(19) United States
(12) Patent Application Publication
(10) Pub. No.: US 2023/0246277 A1
(43) Pub. Date: Aug. 3, 2023

(54) DEVICE FOR HOLDING BATTERY CELLS

(71) Applicant: MTS Maschinenbau GmbH, Mengen (DE)

(72) Inventor: Eckhard LAIBLE, Leinfelden-Schlechtenmuhle (DE)

(73) Assignee: MTS Maschinenbau GmbH, Mengen (DE)

(21) Appl. No.: 17/657,796

(22) Filed: Apr. 4, 2022

(30) Foreign Application Priority Data
Jan. 28, 2022 (DE) 10 2022 102 083.5

(51) Int. Cl. H01M 50/24; H01M 50/242

(52) U.S. Cl. CPC H01M 50/24; H01M 50/242; B65D 2585/88

(57) ABSTRACT

In a device for accommodating battery cells stacking columns are to be arranged on the base frame, which stacking columns have rotatable latches which limit a passage for the battery cells.

### CROSS-REFERENCE TO RELATED APPLICATIONS

This application claims priority to German Patent Application Number 102022102083.5 filed on Jan. 28, 2022, the content of which is incorporated herein by reference in its entirety.

### FIELD OF TECHNOLOGY

The invention refers to a device for holding battery cells with a base frame.

### BACKGROUND

In the course of the expansion of electromobility, the handling of batteries is attracting increasing attention. Batteries are dangerous goods, especially during transport, not only because of their contents, e.g., battery acid, but also because the electricity they contain can generate unwanted heat that can even lead to fire. In addition, batteries are extremely heavy, especially since relatively large batteries are now being produced for electric cars, for example. The handling of these batteries, both charged and discharged, during transport to and from the consumer, presents a major problem.

For example, the DE 10 2011 009 696 A1 shows a transport device for electrochemical energy storage devices. Here, a barrier device is provided in a receiving space, which shields at least in sections in at least one direction and consists of appropriate materials.

The DE 20 2012 007 258 U1 describes a dangerous goods container comprising an outer container, an inner container enclosed by the outer container and enclosing a loading space, and a fireproof insulation arranged between the outer container and the inner container. Further, a pressure relief line connects the loading space to an outer wall of the outer container.

The DE 20 2014 004 436.8 also shows a safety container for dangerous goods, in particular batteries. In this case, an inner compartment is provided which is fully formed as a barrier for solid particles, which is completely surrounded by an outer compartment and which is permeable to gases or fluids in certain areas or as a whole.

In the DE 10 2014 200 879 A1, a battery is held by an inner container and this is inserted in an outer container. The inner container is horizontally and vertically sprung with respect to the outer container by a spring and/or horizontally and vertically damped by a vibration damper.

### SUMMARY

### Object

The object of the present invention is to present a device of the above type in which corresponding battery cells can be easily accommodated or securely fixed for storage and transport.

### Solution of the Object

The solution of the object is that stacking columns are arranged on the base frame, which have rotatable latches that limit a passage for the battery cells.

Stacking columns are known and on the market in a variety of forms and designs. To this day, they are used exclusively for the storage of body parts and are generally associated with a corresponding parts press. The mother of the stacking column is described in the DE 38 11 310 C2. It is characterized by the fact that three latches arranged one above the other cooperate with each other, in which a lowermost latch is in the standby position, rotates into the working position when the stock is placed on it, and in doing so entrains the next latch in the standby position, while all the latches above it are in the rest position, allowing the stock to be inserted between them without interference. To ensure this sequence of movements, the latches can be connected, for example, via a linkage according to the DE 20 2020 104 696 U1.

The basic idea of the present invention is to make such stacking columns applicable for receiving battery cells as dangerous and heavy loads. This involves arranging a plurality of stacking columns on a base frame so that they can receive battery cells between them. The latches must therefore be able to assume a rest position in which they do not hinder the insertion of the battery cells. Only in the standby position they enter the area of the contour of the battery cell, which means that a distance between two opposing latches is less than a length and/or a width of the battery cell. Thus, the battery cell itself or an annular collar surrounding it can hit the latch and rotate it into working position. The linkage is then used to bring a subsequent latch back into the standby position to support subsequent battery cells.

As is usual with known stacking columns, the latch arrangement with the linkage is also to be arranged in a housing in the present case, which is placed either directly on the base frame or via a base plate on the base frame. Since the battery cells are a very heavy load, it is additionally provided that support wings are formed on a rear wall of the housing, which ensure that the housing with the latches is in an exact vertical position.

Furthermore, in a preferred embodiment, guide strips are also provided on the housing, which serve to guide the battery cells between the stacking columns. In order to insert these battery cells between individual guide strips, an upper edge of the guide strips is to be designed offset outwards.

In a preferred embodiment, the latch rotates around an axis of rotation that passes not only through the latch but also through two side panels of the housing. In one embodiment, a torsion spring may be placed on this axis of rotation, having one leg supported against the rear wall of the housing while the other leg engages under a bearing surface of the latch. This torsion spring is preloaded in such a way that it allows the latch to be returned from the working position to the standby position or to the rest position.

As mentioned above, the latches have to carry a significant weight. For this reason, they are preferably formed from metal and have a profile which is very rigid. For example, this profile may consist of a bearing surface and side strips folded away from it, so that this profile is u-shaped in cross-section. Furthermore, an additional support is also provided in the working position, which extends between the side panels of the housing and on which the latch rests.

A damping pad is also provided on the bearing surface, which damps the battery cells or their movement, in particular during transport. At the same time, this damping pad can also be designed to prevent an electrical short circuit between the battery and metal parts of the device according to the invention. Battery cells can be in the form of battery modules, batteries, accumulators or other energy storage devices. They can have any geometric configuration.

In principle, protection is also sought for the use of stacking columns with latches that are movable from a rest position to a standby position and from a standby position to a working position by means of a linkage to accommodate battery cells.

### BRIEF DESCRIPTION OF THE DRAWINGS

Further advantages, features and details of the invention result from the following description of preferred embodiment and from the drawing; these show in:

FIG. 1 is a side view of a device according to the invention for holding battery cells;

FIG. 2 is a top view of the device according to FIG. 1;

FIG. 3 is a perspective top view of a reduced-scale device as shown in FIG. 1;

FIG. 4 is a perspective view of a stacking column according to the invention from a device for receiving battery cells according to FIGS. 1 to 3;

FIG. 5 is a front view of the stacking column according to FIG. 4; and

FIG. 6 is a longitudinal section through the stacking column according to FIG. 5 along line A-A.

### DETAILED DESCRIPTION

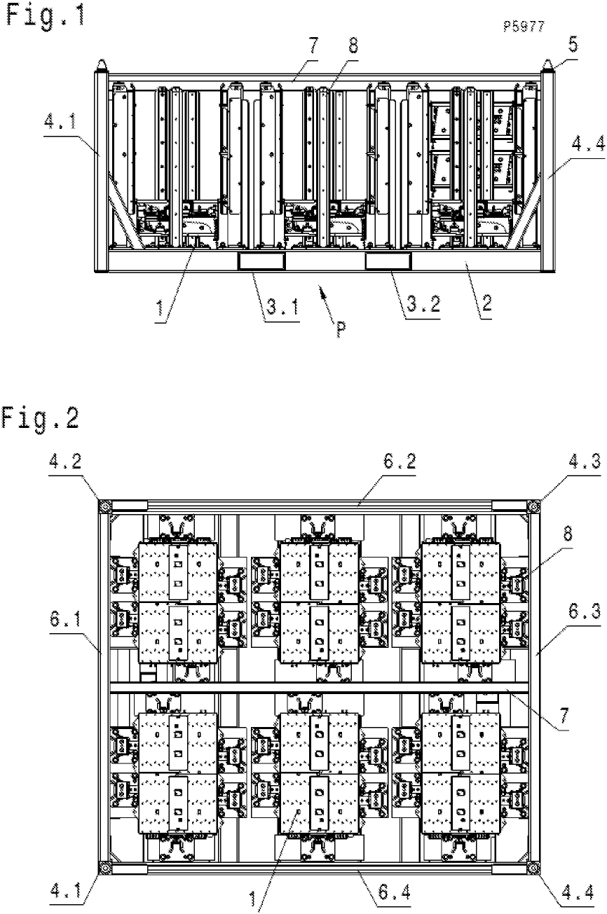

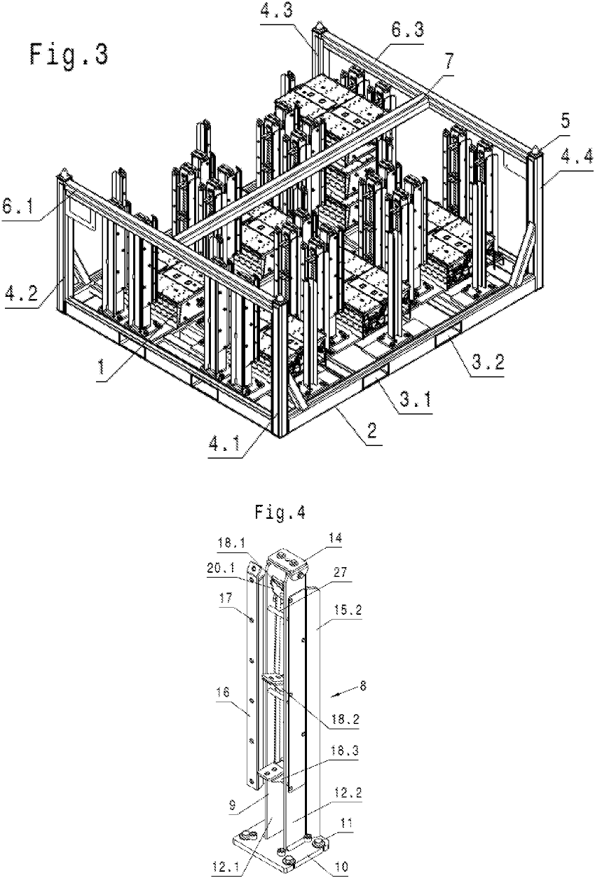

A device P according to the invention for holding battery cells 1 has, according to FIG. 1, a base frame 2 which has engagement openings 3.1 and 3.2 for forks of a forklift truck.

In the corner areas of the base frame 2, corner posts 4.1 to 4.4 project, each of which has a centering cone 5 on its tip. This centering cone 5 interacts with a corresponding base hole, not shown in more detail, of a corner post of a stacked device for holding battery cells, which is set thereon.

In addition, the corner posts 4.1 to 4.4 are connected to each other via side profiles 6.1 and 6.2, whereby the two end side profiles 6.1 and 6.2 are additionally connected to each other via an approximately central connecting profile 7.

From the base frame 2 a plurality of stacking columns 8 project between the corner posts 4.1 to 4.4, whereby according to FIG. 2 six stacking columns 8 each frame a battery cell 1.

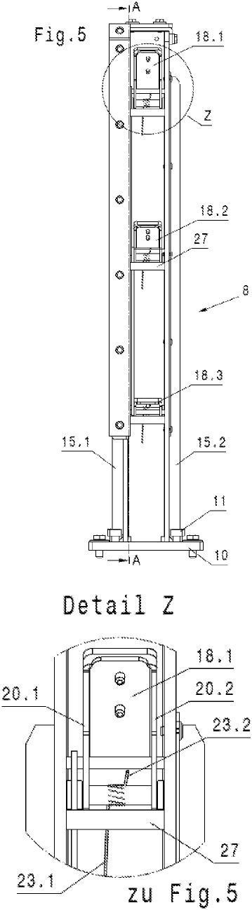

According to FIGS. 4 to 6, a cross-sectionally U-shaped housing 9 is seated on a base plate 10 for each stacking column 8. In the position of use, this base plate 10 is screwed to the base frame 2 via connecting bolts 11.

The housing 9 has two side panels 12.1 and 12.2 and a rear wall 13, which are connected to form the U-shaped housing 9. The two side panels 12.1 and 12.2 are overlapped at the top by a clamp 14.

At the rear wall 13, two support wings 15.1 and 15.2 are flange-mounted or fastened in any desired manner to the side at an angle and serve to stabilize the housing 9.

Towards the front of the battery cell 1 to be loaded, a guide strip 16 protrudes from the side panel 12.1, the upper edge 17 of which is slightly offset so that a battery cell can be inserted more easily between the stacking columns 8.

Between the two side panels 12.1 and 12.2 there are three latches 18.1, 18.2 and 18.3. Each latch 18.1 to 18.3 consists of a bearing surface 19 from which side strips 20.1 and 20.2 are folded off laterally. Both side strips are penetrated by an axle bolt 21, which also penetrates the two side panels 12.1 and 12.2 of the housing 9 and around which the latch 18.1 to 18.3 can rotate. Furthermore, a torsion spring 22 is placed on the axle bolt 21, one limb 23.1 of which is supported against the rear wall 13, while the other limb 23.2 engages under the bearing surface 19. A damping pad 24 is provided on the bearing surface 19 itself, which on the one hand provides damped support for the battery cell 1, but also isolates it from the other metal parts of the stacking column 8.

The individual latches 18.1 to 18.3 are connected to each other by a linkage 25 which, as known from the prior art, causes the lowermost latch 18.3 to be in the working position, the middle latch 18.2 to be in the standby position and the upper latch 18.1 to be in the rest position.

The functioning of the present invention is as follows:

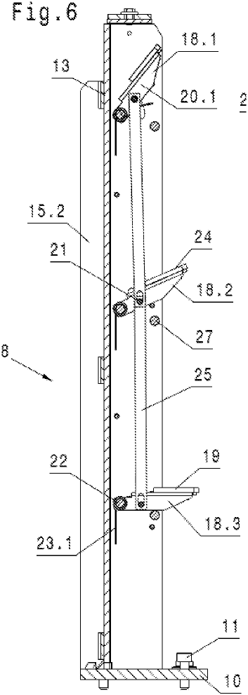

When not yet loaded, the lowermost latch 18.3 is in the standby position corresponding to the middle latch 18.2 shown in FIG. 6, while the middle latch 18.2 is still in the rest position. This means that both latches 18.1 and 18.2 are in the rest position, so that a battery cell can be inserted between the individual stacking columns without interference. However, since in the standby position the individual opposing latches maintain a distance from one another which is less than a width b and a length 1 of the battery cell, the latches engage under an edge strip 26 of the battery cell during insertion of the battery cell and thereby rotate about the axle bolt 21 until the latch 18.3 rests on a support 27. The latch 18.3 also drives the center latch 18.2 via the linkage 25 so that the center latch 18.2 is now in the standby position, as shown in FIG. 6.

When the next battery cell 1 is inserted, it also hits the middle latch 18.2 with its edge strip and rotates it to the working position until it rests on the support 27. In doing so, it takes the upper latch 18.1 with it into the standby position via the linkage 25, so that the upper latches 18.1 can also be charged.

If the battery cells 1 are discharged, the torsion springs 22 return the respective latches 18.1 to 18.3 to their initial positions.

Reference Symbol List

| | |
|---|---|
| 1 | battery cells |
| 2 | base frame |
| 3 | engagement openings |
| 4 | corner posts |
| 5 | centering cone |
| 6 | side profiles |
| 7 | connecting profile |
| 8 | stacking column |
| 9 | housing |
| 10 | base plate |
| 11 | connecting bolts |
| 12 | side panels |
| 13 | rear wall |
| 14 | clamp |
| 15 | support wings |
| 16 | guide strip |
| 17 | edge |
| 18 | latch |
| 19 | bearing surface |
| 20 | side strips |
| 21 | axle bolt |
| 22 | torsion spring |
| 23 | limb/leg |
| 24 | damping pad |
| 25 | linkage |
| 26 | edge strip |
| 27 | support |
| b | width |
| l | length |
| P | device |

1. A device for receiving battery cells with a base frame, characterized in that stacking columns are arranged on the base frame, which have rotatable latches which limit a passage for the battery cells.

2. The device according to claim 1, characterized in that a distance between two opposing latches in the working position is smaller than a width and/or a length of the battery cell.

3. The device according to claim 2, characterized in that the latches rotate from a standby position to the working position when the battery cell is inserted between stacking columns.

4. The device according to claim 3, characterized in that, in the standby position, a distance between two opposing latches is less than a width and/or a length of the battery cell.

5. The device according to claim 1, characterized in that a plurality of the latches is rotatable to a rest position in which a distance between two opposing latches is greater than a width and/or a length of the battery cell.

6. The device according to claim 1, characterized in that a stacking column is provided with a plurality of latches which are connected to one another via a linkage.

7. The device according to claim 6, characterized in that the linkage of a lowermost latch entrains the next-higher latch from its rest position into the standby position when it is rotated from the standby position into the working position.

8. The device according to claim 1, characterized in that the latches are accommodated in a housing with two side panels.

9. The device according to claim 8, characterized in that support wings are formed on the rear of the housing.

10. The device according to claim 8, characterized in that a guide strip protrudes forward from the housing in the direction of the battery cells.

11. The device according to claim 10, characterized in that an upper edge of the guide strip is offset outwards.

12. The device according to claim 8, characterized in that the latch rotates around an axis of rotation which penetrates the two side panels of the housing.

13. The device according to claim 12, characterized in that a torsion spring is arranged on the axis of rotation, which torsion spring is supported on the one hand against a rear wall of the housing and on the other hand against a bearing surface of the latch.

14. The device according to claim 8, characterized in that the latch rests in working position on a support which extends between the two side panels of the housing.

15. The device according to claim 1, characterized in that the latch is covered with a damping pad for the battery cell.

16. The device according claim 1, characterized in that the latch consists of a bearing surface with laterally folded side strips made of metal.

17. A method of stacking columns with latches, which can be moved from a rest position into a standby position and from a standby position into a working position by a linkage, for accommodating battery cells.
